(19) United States
(12) Patent Application Publication
(10) Pub. No.: US 2006/0139954 A1
(43) Pub. Date: Jun. 29, 2006

(54) Display system and lighting device used therein

(76) Inventors: Tomoki Kobori, Kamakura (JP); Satoshi Ouchi, Kamakura (JP); Taro Imahase, Fujisawa (JP); Atsushi Maruyama, Yokohama (JP)

Correspondence Address: MCDERMOTT WILL & EMERY LLP, 600 13TH STREET, N.W., WASHINGTON, DC, 20005-3096, US

(21) Appl. No.: 11/210,108

(22) Filed: Aug. 24, 2005

(30) Foreign Application Priority Data
May 9, 2005 (JP) 2005-135502
Dec. 28, 2004 (JP) 2004-378763

(51) Int. Cl. F21V 7/04

(52) U.S. Cl. 362/613

(57) ABSTRACT

In a drive circuit of light emission device arrays each having at least one light emission device, at least one of the light emission diode arrays is pulse-driven with a pulse of phase different from the other light emission device arrays. While the at least one light emission device array driven with a different phase is OFF, a processing circuit acquires the luminiferous level of each of the other light emission device arrays by using the at least one light emission device array which is OFF as a light reception device. Furthermore, a control circuit controls the drive level of the drive circuit for the light emission device arrays which are ON.

### INCORPORATION BY REFERENCE

The present application claims priorities from Japanese applications JP2004-378763 filed on Dec. 28, 2004 and JP2005-135502 filed on May 9, 2005, the contents of both of which are hereby incorporated by reference into this application.

### BACKGROUND OF THE INVENTION

The present subject matter relates to techniques and equipment to perform image formation by applying a light flux from a light source to a transmissive or reflective liquid crystal panel or a display panel such as a reflection micromirror device and in particular, to a lighting system as a light source used in a display system.

Recently, with increase of luminiferous efficiency of a light emitting diode (hereinafter, referred to as LED), applications of LEDs to high-luminance lighting systems have been growing. However, the LED has problems that the luminiferous level is changed much as the time elapses and irregularities of the luminiferous characteristics are great among LED's. For these reasons, there have been suggested and implemented some methods for maintaining a uniform luminiferous characteristic.

For example, JP-A-2004-296841 discloses a projection type display system having means for measuring, detecting, and deciding deterioration of the semiconductor light source attributable to the operation thereof and a method for measurement and decision, thereby enabling correct notification of exchange of the light source.

### SUMMARY OF THE INVENTION

In a lighting system for driving a plurality of LEDs to obtain a high luminance, if the respective LEDs have irregular luminiferous characteristics, it is preferable to be capable of controlling the luminiferous level of each LED. It is possible to perform correction by detecting the luminiferous level of each LED by using a plurality of photoelectric conversion elements.

However, in order to accurately detect the luminiferous level of each LED, it is necessary to increase the number of the photoelectric conversion elements. This would create new problems in increased parts cost, arrangement and heat radiation.

Hence a need exists for providing a lighting system for controlling a great number of LEDs so as to obtain highly-accurate uniform luminiferous characteristics at a low cost without causing the problem of arrangement, and for providing a display system using the lighting system.

The inventive concepts alleviate the above noted problems with a drive circuit for a plurality of sets of light emitting device array each having at least one light emitting device, wherein for at least one light emitting device array, pulse drive is performed with a different phase from other light emitting device arrays. When at least one light emitting device array driven by a different phase is turned OFF or extinguished, a processing circuit determines the luminiferous level of each of the other light emitting device arrays which are turned ON or lit by using the at least one extinguished light emitting device array as a light reception element. Furthermore, the control circuit controls the drive level of the drive circuit for the light emitting device arrays being lit based on the luminiferous level determined.

Other objects, features and advantages of the invention will become apparent from the following description of the embodiments of the invention taken in conjunction with the accompanying drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a diagram showing a configuration of a lighting system according to a first embodiment of the present invention.

FIGS. 2A-2D are layout maps of the LED array used in the first embodiment.

FIG. 3 is a signal waveform diagram complementing the first embodiment.

FIG. 4 is a diagram showing a configuration of a display system according to a second embodiment.

FIG. 5 is a diagram showing a configuration of the lighting system according to a third embodiment.

FIG. 6 is a layout map of the LED array used in the third embodiment.

FIG. 7 is a layout map of the LED array used in the third embodiment.

FIG. 8 is a signal waveform diagram complementing the third embodiment.

FIG. 9 is another signal waveform diagram complementing the third embodiment.

FIG. 10 is another signal waveform diagram complementing the third embodiment.

FIG. 11 is a diagram showing a configuration of the display system according to a fourth embodiment.

FIG. 12 is a diagram showing another configuration of the display system according to the second embodiment.

### DESCRIPTION OF THE EMBODIMENTS

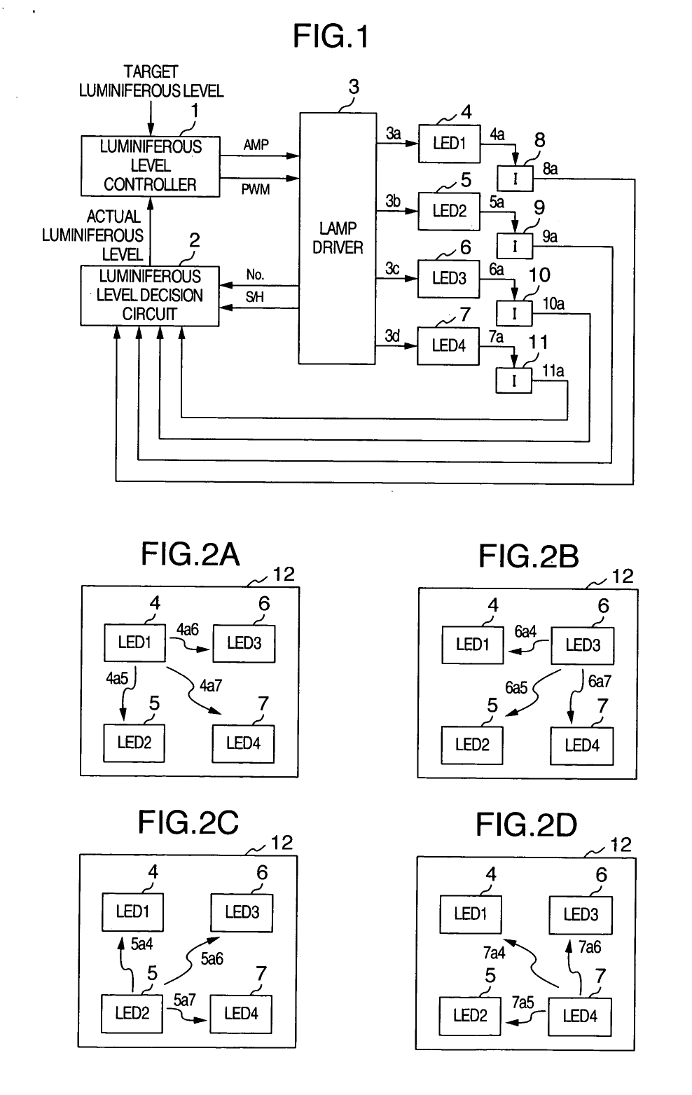

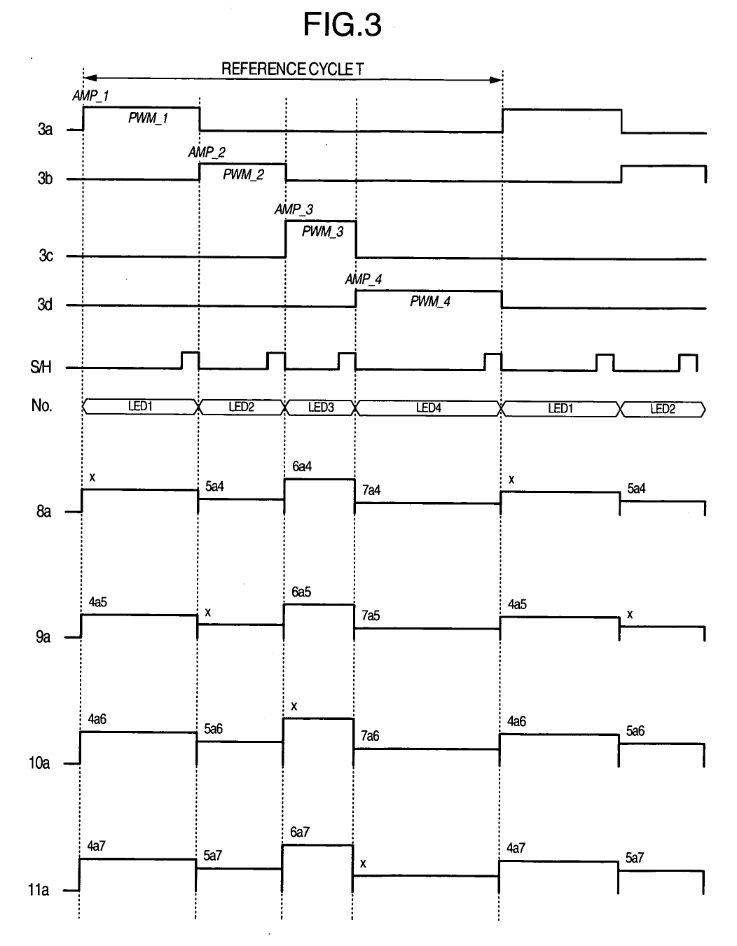

FIG. 1 is a block diagram showing a lighting system according to a first embodiment of the present invention. FIG. 2 is a layout map showing an example of layout method of light emitting devices of the lighting system according to the present invention. FIG. 3 is a signal wave form showing the operation timing and the operation state in each processing section.

Here, as the light emitting device in this embodiment, explanation will be give on the case of LED. Moreover, in this embodiment, the luminiferous efficiency and the luminiferous level as the luminiferous performance of the LED is not to be limited to particular ones and may be any if a luminiferous level required for the system can be obtained. Moreover, in this embodiment, the light wavelength component emitted by the LED is not limited to a particular one but may be any as long as the LED is so configured that a white component and specific color components of red, blue, green, and the like may be obtained in accordance with a particular use of the lighting system.

Moreover, in this embodiment, light-emission driving of the LED is explained referring to the case of pulse drive for intermittently driving the LED. The ON/OFF interval when performing pulse drive is not limited to a particular one but may be any if the drive interval is in accordance with the light-emission rise and light-extinguishing time performance of the LED.

In FIG. 1, reference numeral 1 denotes a luminiferous level controller, 2 denotes luminiferous level decision circuit, 3 is a lamp driver, 4, 5, 6 and 7 are LEDs, and 8, 9, 10 and 11 are electric power sensors. FIGS. 2A-2D show configurations of an LED array and light emission directions from the LEDs emitting light to the LED emitting no light.

The luminiferous level controller 1 compares the target luminiferous level indicated from outside to the actual luminiferous level decided by the luminiferous level decision circuit 2 so as to obtain differences in illumination and color component and to generate or output an instruction signal to drive and stop the LEDs 4-7 and also generate or output an instruction signal to instruct a drive current amount so as to reduce the difference. In this case, the drive current amount is indicated by an amplitude value AMP and the drive/stop interval is indicated by the drive cycle PWM. By repeatedly executing the processing control periodically or non-periodically, the target luminiferous level is gradually acquired. This processing control determines control amount and the control interval of stable response of the control system and not limited to a particular one.

The lamp driver 3 generates a timing signal by setting, as a reference cycle T, such a time interval that meets the time for enabling the LED to obtain stable luminiferous response and extinguishing response, the time for sufficiently obtaining a desired luminiferous level and the time required for detection, calculation and correction. Furthermore, the lamp driver 3 generates a pulse width corresponding to the luminiferous period among the LEDs 4-7, a sampling timing signal S/H for sampling the generated electric power obtained by photoelectric conversion made in the LED during the OFF period thereof, and to-be-sampled object information No indicating what is sampled.

According to the amplitude value AMP and the drive cycle PWM, the lamp driver 3 generates the drive signal waveforms 3a to 3d for each of the LEDs 4-7 so as to turn ON and OFF the LEDs 4 to 7. Here, the luminiferous level of the LED which is ON is determined by the drive power. In the drive signal waveforms 3a to 3d in FIG. 3, pulse height indicates the drive power and the period of high pulse indicates the light-ON period.

Moreover, resistors are arranged in parallel, as the electric power sensors 8, 9, 10 and 11, for current detection to detect current amount as a photoelectric conversion output from LEDs 4 to 7 thereby obtaining voltage values 8a to 11a generated in the resistors. Other detection means can also be used if it can detect the current amount generated by the LED and the means is not limited to a particular one. Moreover, the detection result may be replaced by an analog signal by conversion to equivalent voltage value or further, may be replaced by a digital signal, without being limited to a specific one but any signal may be used as far as it indicates the generated current amount.

Here, by using, as a light reception element, the LED which is turned OFF, electric power as a photoelectric conversion output is detected. More specifically, LEDs in the off period from among the LEDs 4-7 receive light from another LED of ON period so as to be optically excited and electric current are generated by photoelectric conversion function and converted by the electric power sensors 8-11 to output the amount of the current.

The luminiferous level decision circuit 2 measures in advance characteristics of the LEDs 4-7, i.e., (1) luminiferous characteristic indicating the relationship between the power applied and the luminiferous level, (2) photoelectric conversion characteristic indicating the relationship between the light reception level—generated current (voltage), and (3) achieved light reception ratio decided by the distance/position relationship of the LEDs 4-7 and stores them as table data.

The luminiferous level decision circuit 2 identifies the LED which is ON and the LED which is OFF among the LED 4-7 from the sampling timing signal S/H and the sample object information No indicating the sample object. From the voltage values 8a to 11a by the electric power sensors 8, 9, 10 and 11, the voltage value of the LED in OFF period is acquired. The light reception level is identified from the photoelectric characteristic from the table data. Furthermore, the distance/position relationship is corrected by the achieved light reception ratio. Thus, the luminiferous level of the LED which is in the ON period is calculated/identified. This operation is successively performed while switching over between the LEDs 4-7, thereby acquiring the respective actual luminiferous levels.

For example, when the layout of the LEDs which are in ON/OFF period is set as shown in FIGS. 2A-2D, the light emission direction and the longitudinal coverage (travel distance) are decided. By successively switching over the relationship between the LED which is ON and the LEDs which are OFF, the actual luminiferous state of each LED is detected.

In the example of FIGS. 2A-2D, one LED is in ON period. However, the luminiferous level can also be calculated from the layout relationship of the LED even when a plurality of LEDs are in ON period. Moreover, by arbitrarily changing the PWM interval, the number of times, the phase for each LED so as to diversify the ON/OFF relationship, it is possible to realize the variety of the LED layout relationship to calculate the luminiferous level. That is, by changing the LED ON/OFF combination in the time sequence, the liminiferous state of the LED at a particular position is detected. The photoelectric conversion amount of the LED is decided by the LED manufacturing method and material and not limited to a particular one.

Moreover, by acquiring the LED drive condition, drive characteristic and a rough tendency of the deterioration characteristic with time, which are previously known, as table data, it is possible to improve the calculation accuracy of the luminiferous level.

In the aforementioned embodiment, by using the LED also as the photoelectric conversion element (photo-sensor), it is possible to accurately detect luminiferous irregularities between the adjacent LEDs in the LED array and perform a highly accurate luminiferous level control as well as easily uniformize the balance of the luminiferous distribution of the LED array. Moreover, as compared to the case when a photo-sensor is separately arranged externally, there is no need of a new photo-sensor and accordingly, it is possible to reduce the constraints of the layout position and reduce the cost.

In the aforementioned example, an explanation has been given on a specific configuration of the LED array. However, the present invention is not limited to this configuration. The LED layout method, the number of LEDs, the positional relationship among the LEDs in OFF state and the LEDs ON-driven may be any if the luminiferous state of the LEDs can be detected directly or indirectly. Thus, it is possible to easily increase the detection accuracy of the luminiferous state of the respective LEDs.

Moreover, the sample frequency of the electric power sensors may be performed simultaneously buy may also be performed alternately by time division. In this case, the sensors can be used for the both and it is possible to reduce the number of electric parts. Moreover, explanation has been given on the case when the LED connection is in parallel. However, it is also possible to connect the LEDs in series so as to detect the electric power of the entire string. In this case, there is no need of providing detection means for each of the LEDs and it is possible to reduce the number of the current detection means.

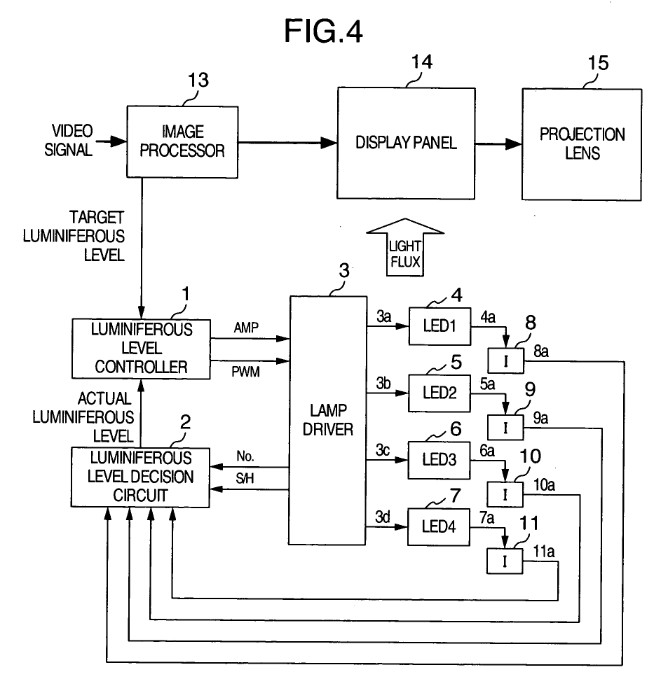

Referring to FIG. 4, explanation will be given on the case that the lighting system shown in the example of FIG. 1 is applied to a light source and a light source control unit of the display system having an image display panel which is arranged to control the light transmission amount or reflection amount in units of the display pixel in accordance with the input video signal.

In FIG. 4, reference numeral 13 denotes an image processor, 14 denotes a display panel for controlling the light transmission amount (or reflection amount). The image processor 13 subjects the inputted video signal various image processes and other processes so as to generate a video display signal. The display panel 14 directly receives the light flux generated by the LEDs 4, 5, 6 and 7 or receives the light flux focused by using the optical parts (not shown) and controls the transmission amount (or reflection amount) of the light flux in units of pixel in accordance with the video display signal. Thus, a video light is generated.

The video light thus obtained is directly viewed or the light is introduced by optical parts (not shown) and projected by a projection lens 15 onto the screen to display the light and shade. Furthermore, the image processor 13 controls the luminiferous level to the luminiferous control circuit 1 in a linking relation with the brightness and color components of the input video signal.

As shown in the example of FIG. 4, it is possible to realize a display system capable of easily maintaining luminiferous intensity level and color balance. Furthermore, in synchronization with the image refresh cycle of the input video signal, the luminiferous level of the LED is corrected/controlled, thereby realizing luminiferous level control linking with the video signal and causing no uncomfortable feeling.

Moreover, when the LEDs 4, 5, 6, 7 generate white light, or when the LEDs 4, 5, 6, 7 generate red, green and blue lights in a time sequential manner, or when an LED array has the LEDs 4, 5, 6, 7 respectively emitting red light, blue light, and green light, or when an LED array emits different color components, by controlling the luminiferous level of a particular color in accordance with the input video signal, it is possible to easily perform video reproduction with a desired color distribution with a high accuracy.

Moreover, control to increase/decrease the luminiferous level can be instructed from outside of the display system or from separate control means. The instruction can be performed in accordance with the environment condition such as brightness and temperature as well as a subjective condition of an observer.

As has been described above, by using the LED also as a photoelectric conversion element (photo-sensor), it is possible to accurately detect the luminiferous irregularities between the adjacent LEDs in the LED array, perform a highly accurate luminiferous level control, and easily uniformize the luminiferous level distribution of the LED array. Moreover, as compared to the case when a separate photo-sensor is arranged outside, it is possible to reduce the number of photo-sensors or reduce the constraints of the layout and easily reduce the cost. Moreover, by arranging the lighting system of FIG. 1 as a light source, it is possible to obtain a display system capable of easily maintaining a uniform luminiferous intensity and color balance.

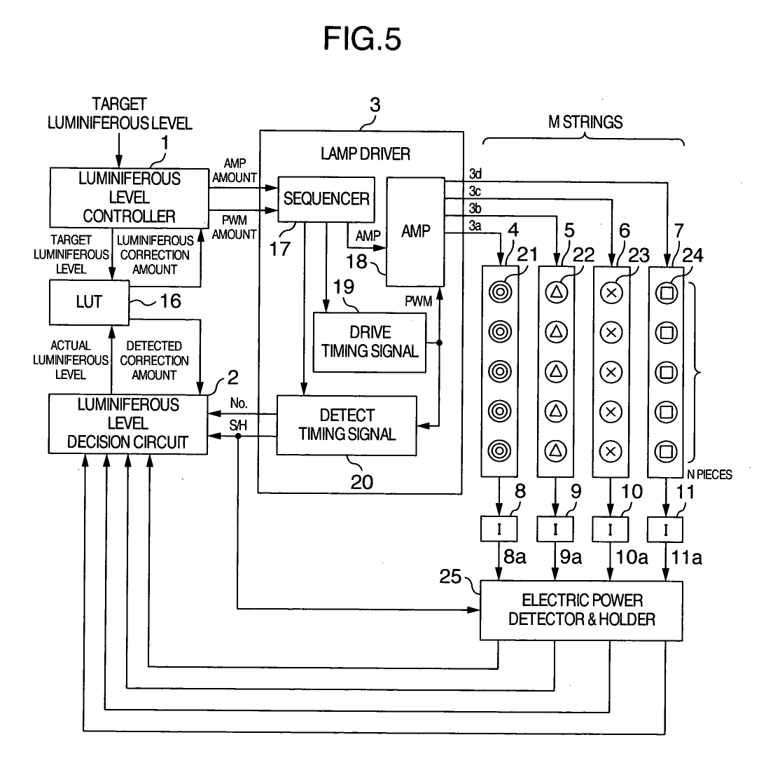

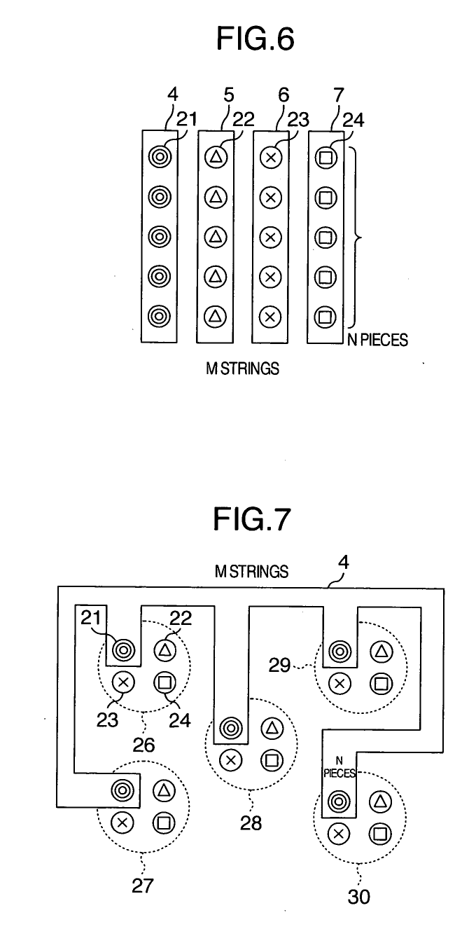

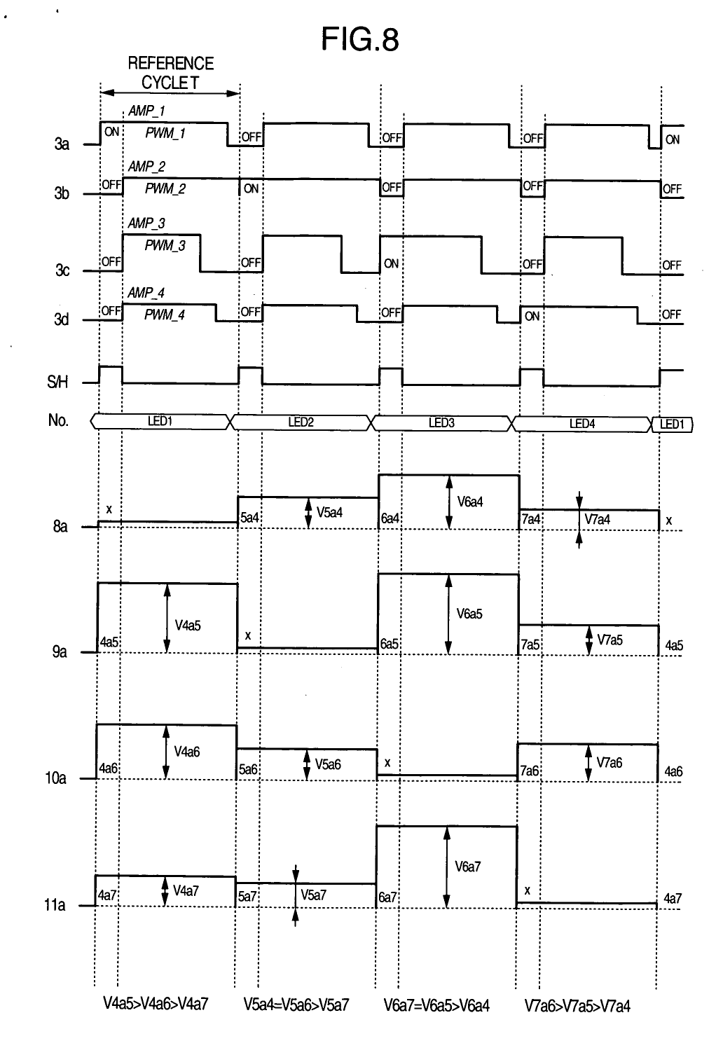

FIG. 5 is a block diagram showing a lighting system according to another embodiment. FIGS. 6 and 7 are layout maps showing an example of layout of a plurality of light emitting devices. FIGS. 8, 9, 10 are signal waveforms showing the operation timing and operation state in each processing units. It should be noted that like reference numerals as in the aforementioned first and second embodiments have the same functions and their explanations are omitted in this embodiment. However, the LED 4-7 will be explained as LED array sets 4-7 each consisting of at least one LED.

In FIGS. 5, 6, 7, reference numeral 16 denotes a LUT (look up table), 17 denotes a sequencer, 18 denotes an AMP (amplifier) having an amplifier and a switch, 19 denotes a drive timing signal generator, 20 denotes a detect timing signal generator, 21 to 24 denote LED devices of the LED array sets 4 to 7, 25 denotes an electric power detector & holder, and 26 to 30 denote LED modules.

FIG. 6 shows an LED array having M (M=4) sets of LED arrays 4 to 7 each having N LEDs 21 to 24 (N=5 in this embodiment). Moreover, for the brevity of explanation, in this embodiment, the LED array sets 4-7 are arranged in parallel to one another, each array having series connected LEDs arranged in a line. It should be noted that in the figure, light emission direction from the LED array sets which are ON toward the LED array sets which are OFF is not depicted, but they are similar to the light emission direction in FIG. 2.

FIG. 7 shows an example of LED array sets 4 to 7 (M=4), each formed by N LEDs (N=5) connected in series. Unlike FIG. 6, each of the LED array sets 4 to 7 (M=4) is realized by LED groups 26 to 30 (N) in which one of the LED devices 21 to 24 is in the proximity. It should be noted that in this embodiment, the layout relation among the LED groups 26 to 30 may be in the proximity layout relation, light-shielding layout relation, or remote layout relation and not limited to a particular one. Moreover, the values of N and M are not limited to particular ones and can be decided arbitrarily in accordance with the LED performance and the luminiferous level required.

In the LUT 16, the target luminiferous level and the actual luminiferous level to be described later are acquired and the luminiferous correction amount is generated so as to reduce the difference from the actual luminiferous level. Moreover, (1) luminiferous characteristic indicating the relationship between the power applied and the luminiferous level, (2) photoelectric conversion characteristic indicating the relationship between the light reception amount and the current generated (voltage), and (3) achieved light reception ratio determined from the distance/position relationship between the LED array sets 4 to 7 are measured in advance and stored as table data. As a detection correction amount, a correction amount of the distance/position relationship based on the conversion correction amount and the achieved light reception ratio upon specifying the light reception amount from the photoelectric conversion characteristic is generated when calculating the luminiferous level of the LED array sets 4-7 which are ON from the electric power generated by the photoelectric conversion by the LED array sets 4-7 which are OFF when each of the LED array sets 4 to 7 emits the target luminiferous level or a luminiferous level which is specified separately and which will be detailed later.

The characteristics of the luminiferous correction amount and the detection correction amount are determined by the LED used, it is possible to measure the characteristics in advance and set them in the table data.

The luminiferous level controller 1 acquires the target luminiferous level and the luminiferous correction amount from the LUT 16 and instructs the AMP amount and the PWM amount as the drive power for each of the LED array sets 4 to 7. According to the AMP amount and the PWM amount, the sequencer 17 in the lam driver 3 decides the drive sequence for each of the LED array sets 4 to 7. In this case, the sequencer 17 instructs the AMP amount AMP_1-4, the drive timing, the duty ratio, and the time distribution of the luminiferous level detection object and the detection timing.

The drive timing signal generator 19 generates the PWM_1-4 signals deciding the drive distribution between the LED array sets 4-7 within the reference cycle T shown in FIG. 8. The AMP circuit 18 drives and extinguishes the LED array sets 4-7 by the PWM_1-4 ON/OFF timing and the AMP amount AMP_1-4 power. In this embodiment, an example is given for the case that a luminiferous level is detected once in a reference cycle T by providing the luminiferous level detection period S/H.

The electric power detector & holder 25 acquires voltage values 8a to 11a obtained by converting the photoelectric conversion output by the electric power sensors 8, 9, 10, 11 in the same way as the embodiment of FIG. 1 and holds/outputs the voltage value of the luminiferous level detection period S/H as a luminiferous level detection result.

The luminiferous level decision circuit 2 acquires the No. of the LED array set which is ON for luminiferous level detection, the luminiferous level detection period S/H, and the detection correction amount of each of the LED array sets 4-7 from the LUT 16 and calculates the electric power detection result of each of the LED array sets 4-7 to thereby decide an actual liminiferous level.

When there is a difference between the target luminiferous level and the actual luminiferous level, a luminiferous correction amount is supplied from the LUT 16 to the luminiferous level controller 1 so as to reduce the difference. With the aforementioned configuration and processes, it is possible to obtain coincidence between the target luminiferous level and the actual luminiferous level.

Firstly, explanation is given on a case that a distance is provided between the LED array sets which are ON and the LED arrays which are OFF as in the layout shown in FIG. 6 and the LED array set whose luminiferous level is to be detected for each reference frequency T is successively switched over as shown in the timing diagram of FIG. 8. For example, when the LED array set 4 is the luminiferous level detection object, the photoelectric conversion outputs V4a5, V4a6, V4a7 of the LED array sets 5, 6, 7 are obtained by the electric power detector & holder 25. Here, in the Vman, m represents the number of the LED array set of the luminiferous level detection object and n represents the number of the LED array set to be detected. In this case, depending on the layout distance, the relationship V4a5>V4a6>V4a7 is satisfied. Similarly, when the LED array sets 5, 6, 7 are respectively the luminiferous level detection objects, the relationships V5a4≈V5a6>V5a7, V6a5≈V6a7>V6a4, and V7a6>V7a5>V7a4 are satisfied. The electric power depending on this layout distance is normalized by the correction amount of the distance/position relationship based on the achieved light reception ratio by the LUT 16.

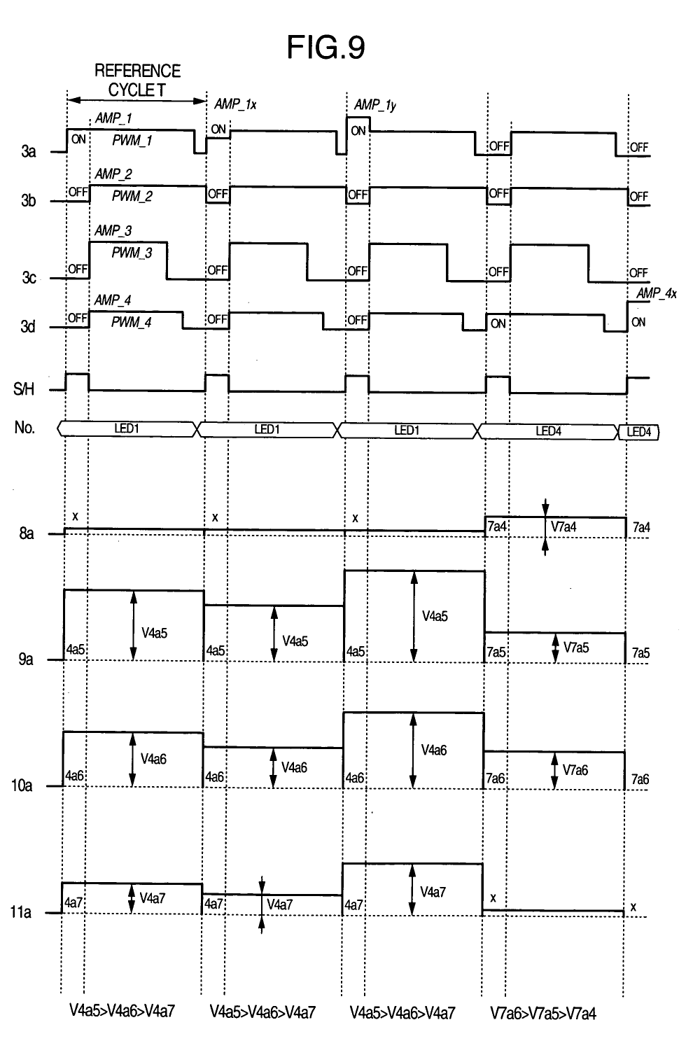

Next, a change of electric power detection result is measured by maintaining the predetermined number (3 in this example) of the LED array sets as the luminiferous level detection objects in a reference cycle T and changing the LED drive power as in the timing diagram of FIG. 9. When the LED array 4 is the luminiferous level detection object, the drive power AMP_1, AMP_1x, AMP_1y (AMP_1y>AMP_1>AMP_1x) and the electric power detection result depending on the layout distance can be obtained. The results are subjected to the position correction of the drive power and the electric power detection result by the table data in the LUT 16 and the luminiferous level decision circuit 2 so as to generate an actual luminiferous level. In this case, it is also possible to switch the drive power within one S/H period. Moreover, it is also possible to simultaneously change the LED array set and the LED drive power for each reference cycle T.

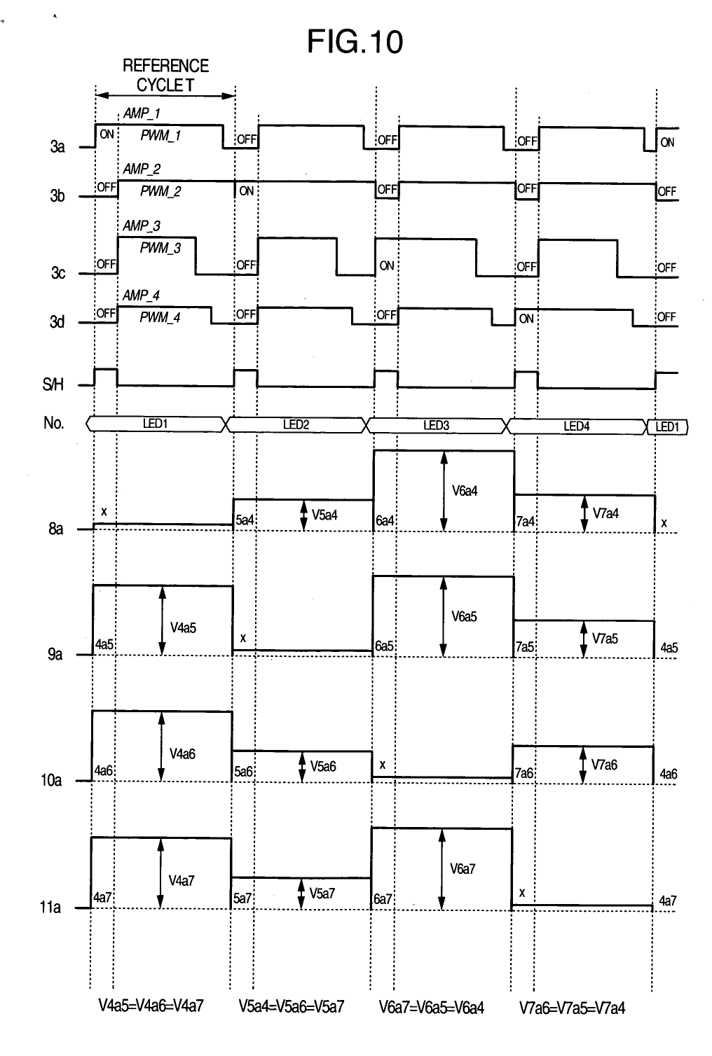

Next, explanation will be given on the layout as shown in FIG. 7 when the distances between the LED array sets which are ON and the LED array sets which are OFF are identical, i.e., the relationship between the light emission and light reception is optimal. In this case, even if the LED array sets of the luminiferous level detection object are successively switched over as in the timing diagram of FIG. 10, the luminiferous level detection outputs have values almost identical to V4a5=V4a6=V4a7, V5a6=V5a7=V5a4, V6a7=V6a4=V6a5, V7a4=V7a5=V7a6.

Although not depicted, even in the layout of FIG. 7, it is also possible to perform the luminiferous level detection by the similar processing like in the timing of FIG. 9.

In this embodiment, since the same elements are used for light emission and light reception, it is easy to control the light emission timing and light reception timing. By providing a small luminiferous level detection period separately from the main luminiferous period, it is possible to improve the luminiferous detection accuracy. Moreover, since it is possible to accurately detect the correlation between the drive power change and the luminiferous level change, it is possible to accurately control the luminiferous level of the LED.

Furthermore, since the luminiferous detection is performed mutually between the LEDs arranged in the proximity, it is easy to improve the luminiferous detection accuracy and detect/follow the change of the LED characteristics, thereby realizing a stable LED luminiferous level.

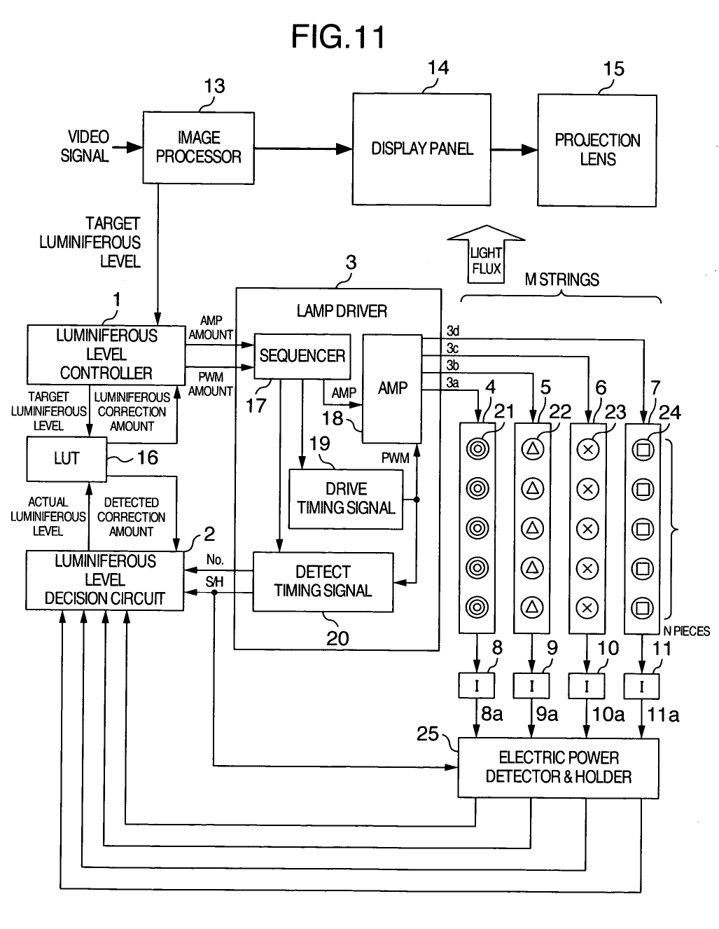

Like the embodiment of FIG. 4, FIG. 11 shows an embodiment in which the lighting system shown in FIG. 5 is applied to the light source and the light source control unit in a display system having a display panel capable of controlling the light transmission amount or reflection amount in the display pixel unit according to the input video signal. Like reference numerals denote the same functions and their explanations are omitted.

In addition to the advantages obtained by the embodiment of FIG. 4, the embodiment of FIG. 11 can achieve a display system capable of easily holding uniform luminiferous intensity/color balance since it is possible to detect the respective luminiferous states of the LED array sets 4-7.

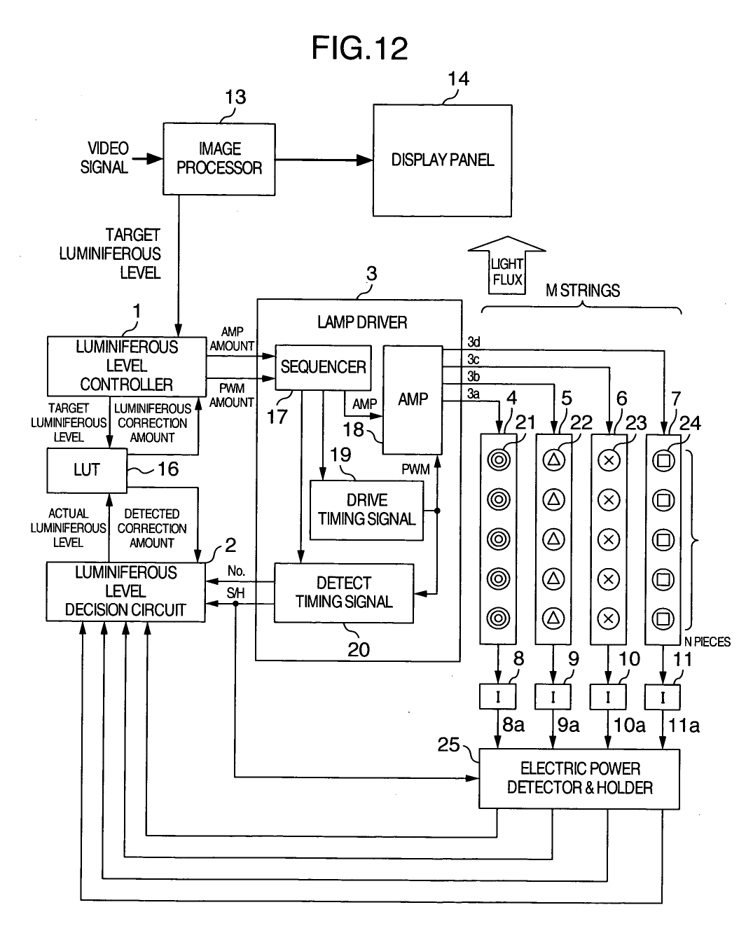

It should be noted that in the display system of FIG. 4 or FIG. 11, explanation has been given on the projector device for projecting/displaying on a screen or the like. However, the present invention is not to be limited to this. For example, the present invention can be applied to a display device to which the LED can be applied such as the lighting system of the direct view liquid crystal display device not using the projection lens 15 shown in FIG. 12.

As has been explained the respective embodiments, there is no need of a new photo-sensor and it is possible to reduce the cost. Furthermore, by performing control according to the detection results obtained between the LEDs in the proximity, it is possible to realize uniform LED luminiferous level.

It should be further understood by those skilled in the art that although the foregoing description has been made on embodiments of the invention, the invention is not limited thereto and various changes and modifications may be made without departing from the spirit of the invention and the scope of the appended claims.

1. A lighting device comprising:
a plurality of light emission device arrays, each having at least one light emission device;
a drive circuit for pulse-driving at least one of the light emission device arrays with a pulse of phase different from the other light emission device arrays;
a processing circuit for calculating the luminiferous level of each of the other light emission device arrays using the at least one light emission device array as a light reception device while it is OFF, and
a control circuit for controlling the drive level of the other light emission device arrays which are ON, according to the luminiferous level of each of the other light emission device arrays.

2. A lighting device according to claim 1, wherein
the processing circuit comprises:
a sensor for detecting a photoelectric conversion output from the light emission device arrays when they are OFF;
a luminiferous level decision circuit for deciding the luminiferous level of each of the light emission device arrays from the photoelectric conversion output, the decision circuit deciding the luminiferous level of the light emission device arrays when they are ON according to the photoelectric conversion output amount of the light emission device arrays when they are OFF, light emission distribution based on the layout position relationship, and known light emission characteristic of each of the light emission device arrays.

3. A lighting device according to claim 1, wherein the drive circuit and the control circuit perform control to obtain a predetermined luminiferous level.

4. A lighting device according to claim 1, wherein the control circuit controls the drive power of the light emission device arrays.

5. A lighting device according to claim 1, wherein M (M≧1) of the light emission device arrays each having N (N≧1) light emission devices connected are provided.

6. A lighting device according to claim 5, wherein the M light emission device arrays are arranged in parallel to one another.

7. A lighting device according to claim 5, wherein the light emission device arrays are arranged in such a manner that N light emission device groups each having M light emission devices each selected from each of the M light emission device arrays are provided.

8. A lighting device according to claim 5, wherein the light emission device arrays are driven to emit light by the drive circuit and the control circuit in the unit of each of M light emission device arrays and the light reception amount is detected by the processing circuit for deciding the luminiferous level.

9. A lighting device according to claim 8, wherein
one of the M light emission device arrays is driven to emit light while the M−1 light emission device arrays detect the light reception amount achieved, and
light emission of the light emission device arrays is successively switched over at a predetermined time interval.

10. A lighting device according to claim 9, the device further comprising s storage circuit for driving the light emission device arrays to emit light while switching over the drive power, detecting the luminiferous level for each drive power, calculating at least one of the light emission characteristic and light reception characteristic of each of the light emission device arrays, and storing the calculation result.

11. A lighting device according to claim 1, wherein the light emission devices are LEDs.

12. A display device comprising:
a lighting device;
a display panel for controlling light transmission amount or reflection amount from the lighting device according to an input video signal; and
a projection device for displaying the transmission light or reflection light from the display panel,
said lighting device comprising:
a plurality of light emission device arrays, each having at least one light emission device;
a drive circuit for pulse-driving at least one of the light emission device arrays with a pulse of phase different from the other light emission device arrays;
a processing circuit for calculating the luminiferous level of each of the other light emission device arrays using the at least one light emission device array as a light reception device while it is OFF; and
a control circuit for controlling the drive level of the other light emission device arrays which are ON, according to the luminiferous level of each of the other light emission device arrays.
